(19) United States
(12) Patent Application Publication
(10) Pub. No.: US 2008/0315616 A1
(43) Pub. Date: Dec. 25, 2008

(54) Method apparatus for extending sun visor in vehicles

(76) Inventor: Jilin Wang, Frisco, TX (US)

Correspondence Address: Jilin Wang and Xiaoli Niu, 7898 Greenvalley Lane, Frisco, TX, 75034, US

(21) Appl. No.: 12/077,675

(22) Filed: Mar. 20, 2008

Related U.S. Application Data
(60) Provisional application No. 60/936,952, filed on Jun. 23, 2007.

(51) Int. Cl. B60J 3/00

(52) U.S. Cl. 296/97.6

(57) ABSTRACT

A glare reducing shield as a sun visor extender for use with traditional existing sun visor and the side window of a vehicle comprises a support bar, elastic band and glare reducing shields which may be in different color and transparent, magnets are used in the easy removable attachments, storages and provides flexibility to shift shield in ways that can deflect or reduce light from different directions.

### CROSS-REFERENCE TO OTHER APPLICATION

Priority is claimed from U.S. provisional application 60/936,952, which is hereby incorporated by reference. This application may be related to the present application, or may merely have some drawings and/or disclosure in common.

### BACKGROUND

The present application relates to a protective device from the Sun, and more particularly to a sun visor extension for using with conventional sun visors in automobile or other vehicles.

Note that the points discussed below may reflect the hindsight gained from the disclosed inventions, and are not necessarily admitted to be prior art.

When people is driving a vehicle in the early morning or in the late afternoon towards to the Sunlight, the glare of sunlight is severe and annoying. It is fatiguing human eyes especially during a long distance drive, it becomes a hazard factor to the driver.

The traditional sun visor of automobile commonly provides a limited level of protection from the sunray when it is flipped downwards or sideways. But it is not effective enough to solve the above glare problem.

In order to reduce the glare of the sunlight, many sun visor extension have been developed over the years.

Description of the Prior Arts

U.S. Pat. No. 4,058,340 disclosed a sun visor extension that contains a wire frame retainer. It is difficult to be used for different type or shape of sun visor.

U.S. Pat. No. 3,853,370 discloses an attachable visor that is mounted on a clamping assembly which includes too many parts and made this item too complex.

U.S. Pat. No. 4,090,732 discloses a sun visor extension using a pair of tracks and hinges to hold the extension panels which is limited to vertical movement.

U.S. Pat. No. 5,104,174 discloses an expandable covered mirror visor that comprises a retraction means and blades. This device contains so many moving parts that increase tremendously the cost.

U.S. Pat. No. 4,635,995 discloses and attachable sun visor uses a clamping device that is in an U-shape which takes a big space and it would scuff the surface of the sun visor.

U.S. Pat. No. 4,982,992 discloses a glare shield which is clipped on the conventional sun visor. This device comprises too many working parts as well.

### SUMMARY

The present application discloses new approaches to efficiently reduce the glare of the sunlight which would irritate and annoy the eyes of the driver and passenger. The approach is to increase the safety and comfort level of driving while lowering the cost of manufacturing so that the products based on this application would be popularized. The disclosed innovations of the new, improved and simple sun visor expender system and sun visor extender, in various embodiments, provide one or more of at least the following advantages:
can be used easily and universally for all kind of conventional sun visor of current automobiles,
easy to attach to the main visor of the vehicle with one hand and without visually measuring the operation,
easily adjustable and can be also easily used on the side window,
in a compact shape that saves space and is easy to store,
low cost and easy to manufacture,
can have several different color shields to meet people's different preference, and
do not constrain the normal use of the existing sun visor even when the extender is attached.

These advantages of the disclosed inventions will become apparent and understood to those skilled in the art as the description thereof with the reference in the following drawings.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 schematically shows the sun visor extender system.

FIG. 2 shows an example of two elastic strips that attaches support bar to existing sun visor.

FIG. 3 shows an example of a support bar.

FIG. 4 shows an example of the sun glare shield.

FIG. 5 shows a side view of the present sun visor extender system.

FIG. 6 shows an alternative position that the sun glare shield can be attached.

FIG. 7 shows another alternative position that the sun glare shield can be attached.

FIG. 8 shows an example to attach the sun glare shield such as the normal use of the existing sun visor is not constrained when the existing sun visor is flipped up or downwards.

FIG. 9 shows the usage of the sun glare shield on the side window of a vehicle.

FIG. 10 shows an example of two double side suction cups that is used to attach the sun glare shield to the side window of an automobile.

### REFERENCE NUMERALS IN DRAWINGS

10 existing sun visor
12 support bar
14 magnet
16 magnet
18 magnet
20 elastic band
22 elastic band
26 sun glare shield
28 magnet
30 magnet
32 magnet
34 double side suction cup
36 double side suction cup

### DETAILED DESCRIPTION OF SAMPLE EMBODIMENTS

The numerous innovative teachings of the present application will be described with particular reference to presently preferred embodiments (by way of example, and not of limitation).

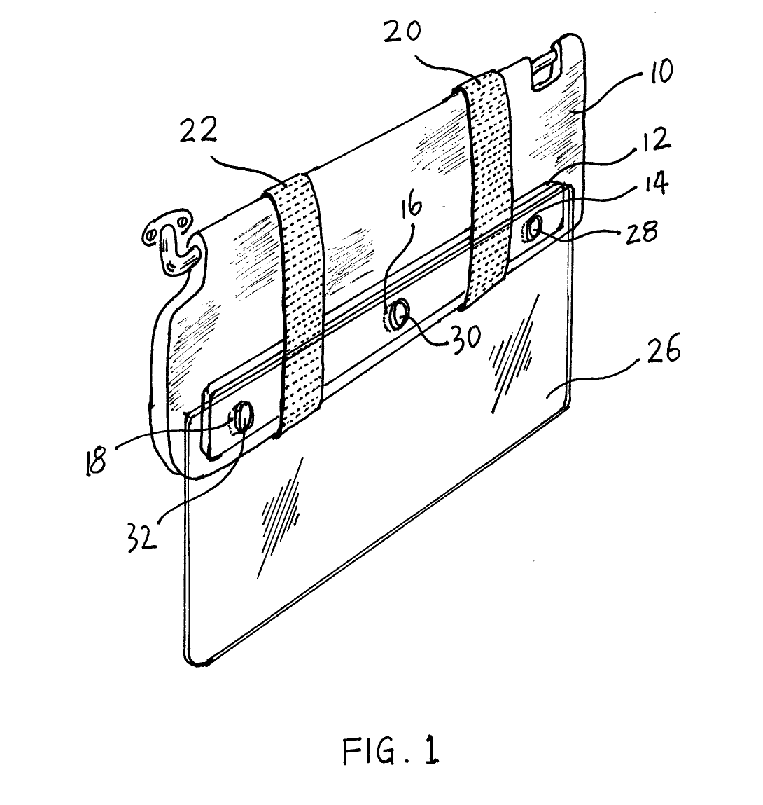

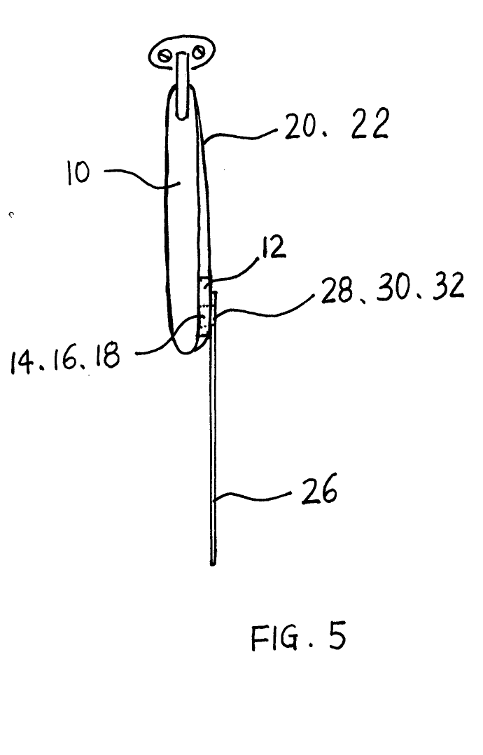

FIG. 1 and FIG. 5 show a preferred embodiment of the disclosed inventions. In those figures, a sun glare shield 26 is used in conjunction with an existing sun visor 10 which is provided in vehicles, automobiles or trucks.

FIG. 3 shows an example of a support bar. The support bar 12 is inlaid with three magnets 14, 16, 18. FIG. 4 shows an example that the sun glare shield 26 is inlaid with three magnets 28, 30, 32, with the size and position matches those magnets on the support bar.

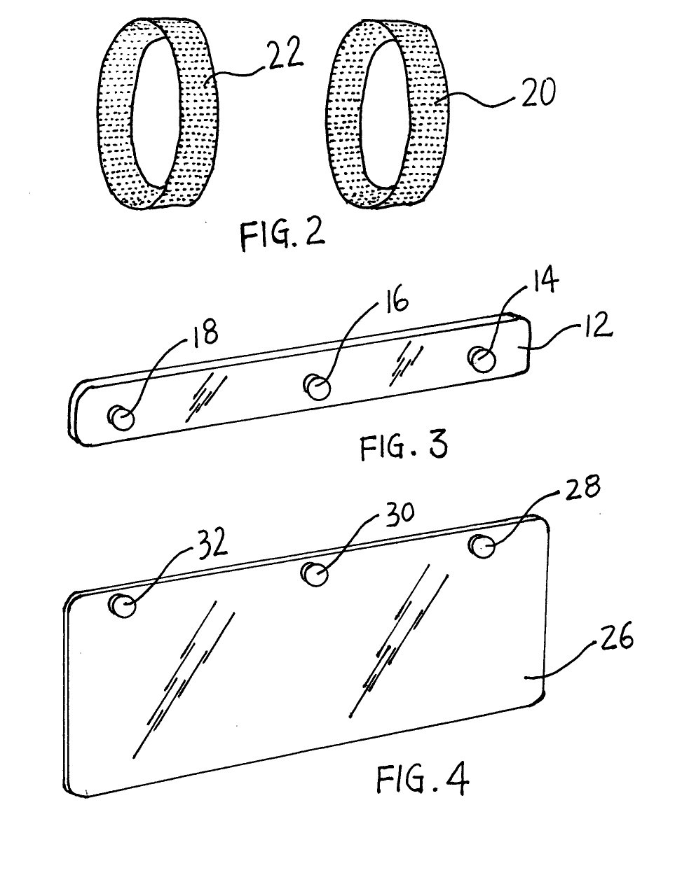

In a preferred embodiment, the support bar 12 is fastened by two elastic bands 20 and 22 (shown in FIG. 2) thereto and at the lower edge of the existing sun visor 10. The sun glare shield 26 is magnetically attracted and attached to the support bar 12. In the position shown in FIG. 1 the sun glare shield 26 is to attenuate or polarize the incoming irritating glare light of the sun and without blocking the vision of the driver or passenger.

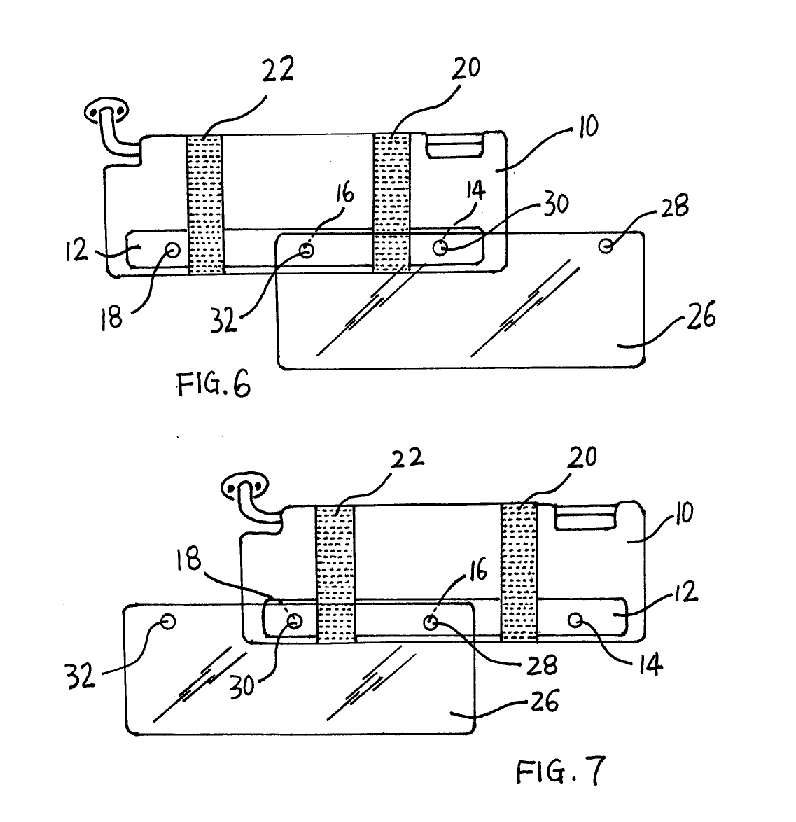

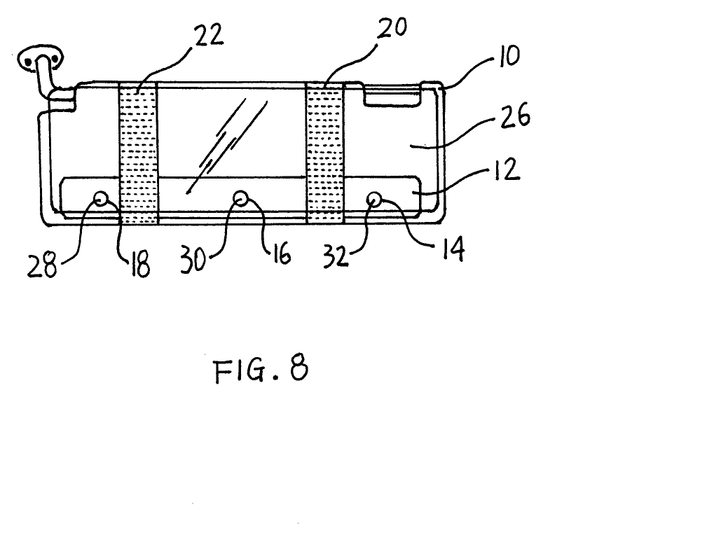

FIG. 6 and FIG. 7 shows two different examples to attach the sun glare shield 26. The attachment position of the sun glare shield 26 can be easily adjusted towards the left or right side of the existing sun visor 10 in order to best deflect the sun glare coming from different direction.

FIG. 8 shows an example that the sun glare shield 26 can be turned over and attached against the back of the existing sun visor 10 in order to be stored thereon and without constraining the normal use of the existing sun visor 10 which may be flipped up against the ceiling of the vehicle.

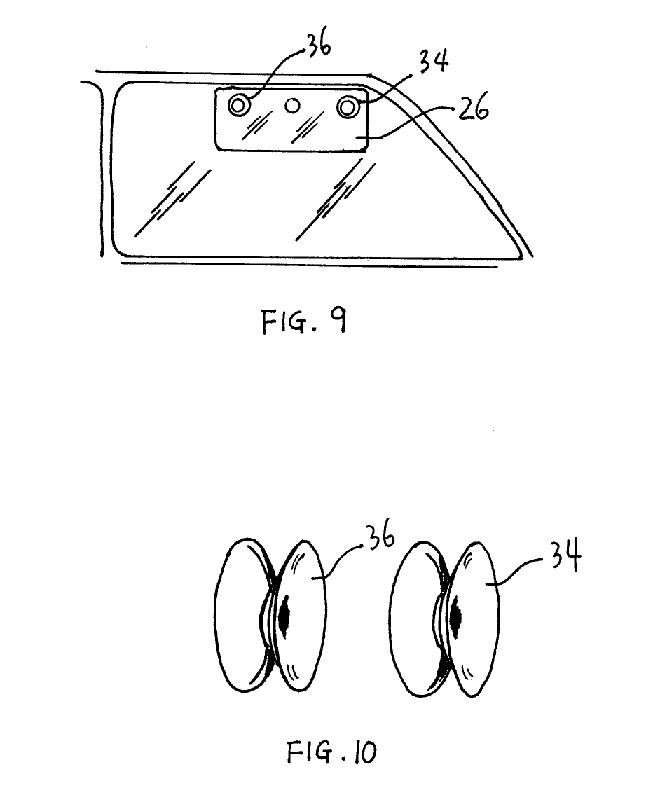

FIG. 9 illustrates an example that the sun glare shield 26 can also be attached in any position needed on the side window of the vehicle by the mean of double side suction cups 34 and 36 which is shown in FIG. 10, or by other alternative means include magnet end of suction cup.

In conclusion, this invention of the sun visor extender is to reduce, attenuate and deflect the glare of sun or the glare light from oncoming vehicle, and to reduce or dim the irritating light from the side window. This sun visor extender has the additional advantages in that
It provides the user the easiest way of utilizing this sun visor extender that comprises the least parts and
Easy to install and easy to store.
It provides a new sun visor extender which will not incur any damaging or wearing to the main existing sun visor.
It allows the manufacturers to manufacture this highly functional and practical product in an extreme low cost.

According to various embodiments, there is provided a sun visor extender to a sun visor of a motor vehicle, comprising: a) a support bar attached to a existing main sun visor of the vehicle; b) support bar attaching means for attaching said support bar to any one of said main existing sun visor of the vehicle; c) a glare reducing shield attachable to said support bar; and d) attaching means of said glare reducing shield for attaching said glare reducing shield to said support bar and or to side window.

According to various embodiments, there is provided a method for protecting vehicle driver from glare of light, comprising the actions of: a) attaching a support bar to an existing visor of the vehicle by using at least one elastic tying means; and b) coupling a glare reducing shield to said support bar; wherein said support bar and said glare reducing shield have the same number (at least two) of magnets along the edges with proximately the same size and positions such that said coupling action (b) is performed by aligning and attaching at least two pairs of said magnets from said support bar and said shield.

According to various embodiments, there is provided a method for protecting vehicle driver from glare of light, comprising the actions of: a) attaching a support bar to an existing visor of the vehicle by using two elastic tying bands that press and wrap said bar tightly to said visor; and b) coupling a glare reducing shield to said support bar; wherein said support bar has at least three extruding columns and said glare reducing shield has, along its edge, holes the same number as said columns, with the size and shape of holes and columns matching each other such that the columns can easily but securely pushed into the holes as coupling action (b) is performed, and preferably the holes and columns are evenly spaced.

It should be obvious that there are variations and modifications to the disclosed innovations. Those variations and modifications should be obvious to those with ordinary skills in the art. For example, in other classes of embodiments, the sun glare shield 26 may be transparent with color or translucent, and may be made in a set of multicolored pieces and or in different size in order to meet the needs therein different circumstances.

For another example, the support bar 12 may be made of plastic or wood which keep the cost of the present invention lowest possible in the market.

Yet, for another example, in another class of embodiments, the support bar may have extruding column made of plastic or metal in place of the previous magnets, and the shield may have holes in place of the previous magnets, with the sizes and shapes of the holes matching the extruding columns such that when the columns are pushed into those holes, the shield is attached to support bar securely yet still can be detached by a little bit force. The shape of the column can be circle, oval, square, star, or any other regular or irregular shapes.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A sun visor extender to a sun visor of a motor vehicle, comprising:
a) a support bar attached to a existing main sun visor of the vehicle;
b) support bar attaching means for attaching said support bar to any one of said main existing sun visor of the vehicle;
c) a glare reducing shield attachable to said support bar; and
d) attaching means of said glare reducing shield for attaching said glare reducing shield to said support bar and or to side window.

2. The sun visor extender of claim 1, wherein said support bar and said glare reducing shield further comprising at least two magnets and said magnets of said glare reducing shield is magnetically attachable to said magnets inlaid on said support bar.

3. The sun visor extender of claim 1, therein said support bar attaching means comprises at least one elastic tying means.

4. The sun visor extender of claim 1, therein said attaching means for attaching said glare reducing shield to side window comprises at least one suction attaching means.

5. The sun visor extender of claim 1, therein said glare reducing shield is transparent.

6. The sun visor extender of claim 1, therein said glare reducing shield is translucent.

7. A method for protecting vehicle driver from glare of light, comprising the actions of:
a) attaching a support bar to an existing visor of the vehicle by using at least one elastic tying means; and
b) coupling a glare reducing shield to said support bar;
wherein said support bar and said glare reducing shield have the same number (at least two) of magnets along the edges with proximately the same size and positions such that said coupling action (b) is performed by aligning and attaching at least two pairs of said magnets from said support bar and said shield.

8. The method of claim 7, wherein said coupling shield action is performed such that the shield is extending out from said visor to protect driver from light glare.

9. The method of claim 7, wherein said coupling shield action is performed such that the shield is laid over said visor for storage.

10. The method of claim 7, wherein said coupling shield action is performed such that at least one left most magnet on the support bar is not attached to any magnet on the shield to deflect or reduce light from right direction.

11. The method of claim 7, therein said shield has at least one suction such that it can be attached to side window.

12. A method for protecting vehicle driver from glare of light, comprising the actions of:
a) attaching a support bar to an existing visor of the vehicle by using two elastic tying bands that press and wrap said bar tightly to said visor; and
b) coupling a glare reducing shield to said support bar;
wherein said support bar has at least three extruding columns and said glare reducing shield has, along its edge, holes the same number as said columns, with the size and shape of holes and columns matching each other such that the columns can easily but securely pushed into the holes as coupling action (b) is performed, and preferably the holes and columns are evenly spaced.

13. The method of claim 12, wherein said coupling shield action is performed such that the shield is extending out from said visor to protect driver from light glare.

14. The method of claim 12, wherein said coupling shield action is performed such that the shield is laid over said visor for storage.

15. The method of claim 12, wherein said coupling shield action is performed such that at least one left most column on the support bar is not attached to any hole on the shield to deflect or reduce light from right direction.

16. The method of claim 12, therein said shield has at least one suction such that it can be attached to side window.

17. The method of claim 12, therein said column is square shaped.

18. The method of claim 12, therein said column is star shaped.

19. The method of claim 12, therein the shape of said column is round circle.

20. The method of claim 12, therein when said support bar and shield are horizontally aligned said holes and columns are aligned but holes are not horizontally aligned.
